(19) United States
(12) Patent Application Publication
(10) Pub. No.: US 2015/0110332 A1
(43) Pub. Date: Apr. 23, 2015

(54) Easy cover for cord on earbuds and earphones

(71) Applicant: Mary Lynn Case, Baltimore, MD (US)

(72) Inventor: Mary Lynn Case, Baltimore, MD (US)

(21) Appl. No.: 14/522,271

(22) Filed: Oct. 23, 2014

Related U.S. Application Data
(60) Provisional application No. 61/894,581, filed on Oct. 23, 2013.
(60) Provisional application No. 61/900,632, filed on Nov. 6, 2013.
(60) Provisional application No. 62/030,764, filed on Jul. 30, 2014.

(51) Int. Cl. H04R 1/10

(52) U.S. Cl. CPC H04R 1/1033
USPC 381/384

(57) ABSTRACT

A decorative cover that surrounds the cord on earbuds and earphones and keeps the cord free of tangles during use and storage. The tubular shape has openings at either end. A plastic threading device is used to push the connector end of the cord through the length of the cover. There is a hook at one end intended for a key, id badge or to hook the cover to a jogging shirt. The cover remains on the cord during use and is easily rolled up and placed in a pocket or bag for tangle-free storage.

### CROSS-REFERENCE TO RELATED APPLICATIONS

Provisional Application No. 61/894,581; filed on 2013 Oct. 23 by present inventor.

Provisional Application No. 61/900,632; filed on 2013 Nov. 6 by present inventor.

Provisional Application No. 62/030,764; filed on 2014 Jul. 7 by present inventor.

### BACKGROUND

Prior art that appears relevant:

U.S. Pat. No. 7,610,661 B2; 2009 Nov. 3 by Sween, Kleeman, Nalwad.

U.S. Pat. No. 8,147,270 B1; 2012 Apr. 3 by Wescott.

U.S. Pat. No. 8,261,416 B2; 2012 Sep. 11 by Rothbaum, Conner, Curtis, Damon, Sanchez.

This application relates to accessories used to manage a cord on earbuds or earphones. In today's market, there are various styles of earbuds and earphones available. The cords on many earbuds/earphones are thin and often become tangled making them difficult to manage. There are existing products that allow earbud/earphone cords to be wrapped around a separate object for storage and cord management. This type of system requires that the user spend time wrapping up the cord tightly after each use to prevent tangles. Furthermore, the separate storage object must be present and available for use when needed. These storage items are often small and can be easily lost or misplaced.

Other storage solutions require that the cord must form a closed loop by fastening either end of the cord to a conical shaped object. However, when the cords are in use, the storage object remains thus awkwardly hanging on the cord. If the large closed loop gets caught on an object, an end of the cord may become detached from the fastener and fall freely.

Storage management structures that involve straps and magnets add unwanted weight to the object to which they are attached. Also, this solution is bulky and visually unappealing.

### SUMMARY

It is an object of the invention to produce a cover that surrounds the cord on earbuds and earphones and keeps the cord free of tangles during use and storage. An additional object of the invention is to provide a solution that is easy to use and visually appealing. Several advantages of one or more aspects are stated below. It is a lightweight covering that wraps around the majority of the length of the cord. The cover remains on the cord during use and is easily rolled up and placed in a pocket or bag for tangle-free storage. Since the cover can always remain on the cord, it will not become misplaced or lost. Considering that earbuds/earphone cords are often exposed during use, many users are concerned with visual appeal. The cover provides a fashion component in that the cover can be personalized given a variety of color choices and patterns.

### DRAWINGS

### Figures

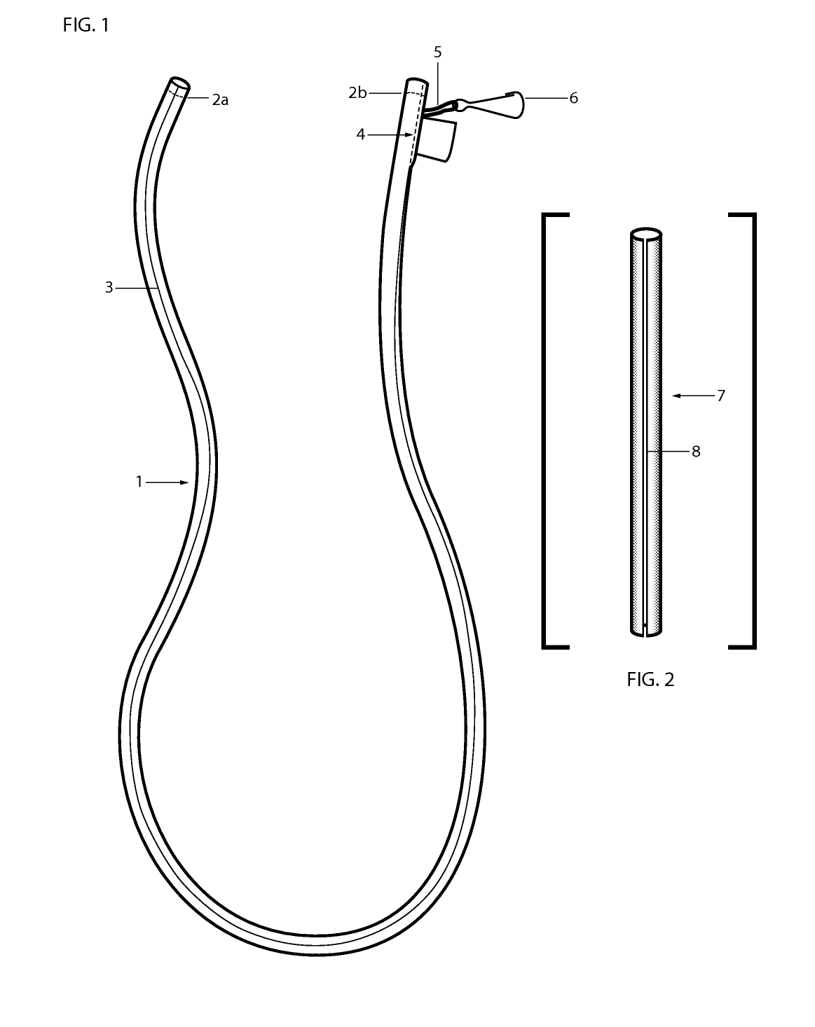

FIG. 1 is a perspective view of a first embodiment

FIG. 2 is an exploded view of a threading device

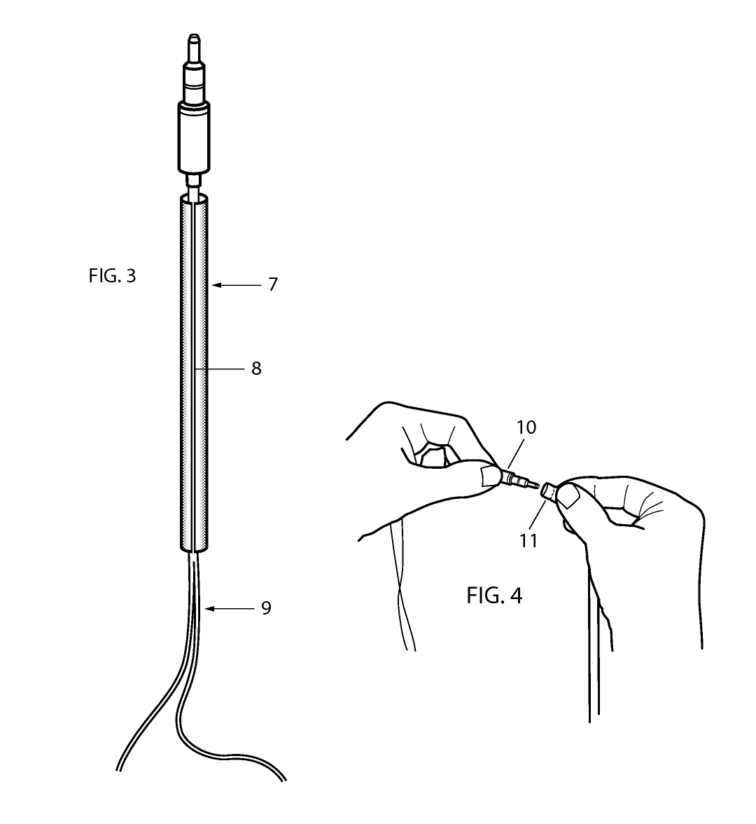

FIG. 3 is a view of the threading device placed around earbuds cords

FIG. 4 shows first step in threading the cord

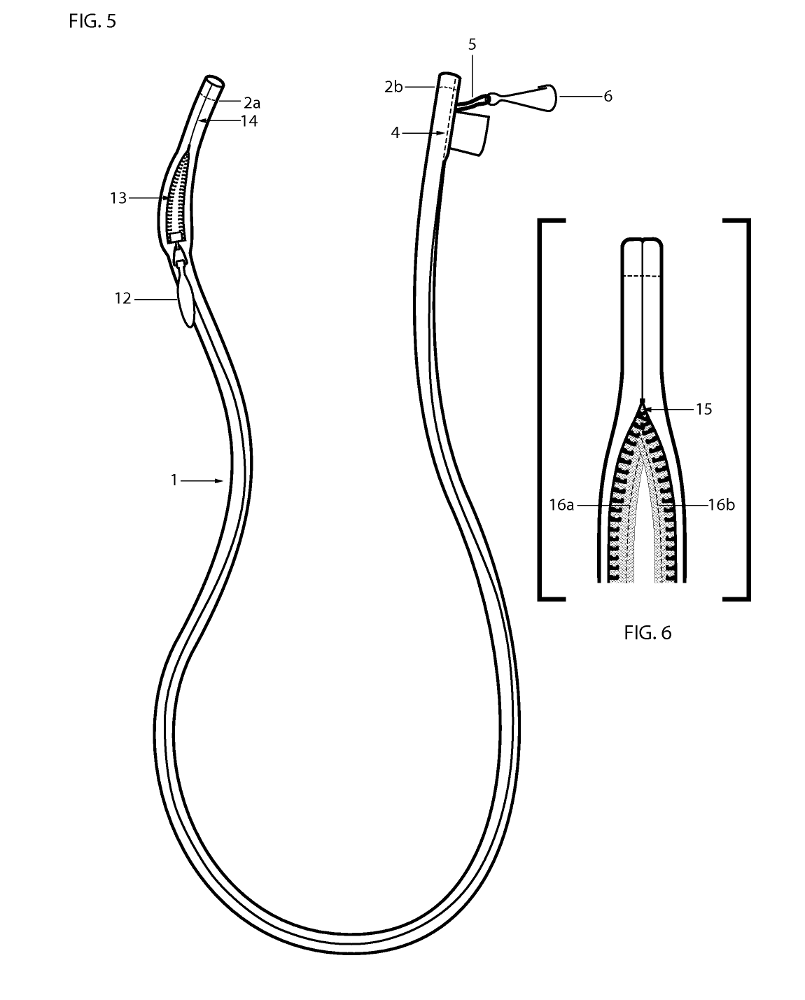

FIG. 5 is a perspective view of a second embodiment

FIG. 6 is an exploded view of stitching on FIG. 5

### REFERENCE NUMBERS

1—fabric of the covering
2a—end hem
2b—end hem
3—vertical seam
4—top stitching
5—cord
6—hook
7—plastic threading device
8—vertical slit
9—earbud/earphone cord
10—earbud connector
11—opening of cover
12—zipper slider
13—zipper tape
14—top seam
15—horizontal tacking stitch
16a—vertical stitching
16b—vertical stitching

### DETAILED DESCRIPTION

FIG. 1 illustrates one embodiment of a cover that will surround the cord on earbuds and earphones. The cover is made of a fabric 1 or any other soft material. The fabric 1 is made of nylon, spandex, polyester, rayon, cotton or any combination of various fabrics. The fabric 1 contains solid colors, printed patterns and other selected printed motifs.

To make the cover in FIG. 1, begin with a piece of fabric 1 with overall dimensions of roughly 32″ by 1 ½″. First hem each end 2a and 2b by turning each end by 1/4″ with wrong sides of the fabric facing and sew to create finished edge. Next, with right sides of the fabric facing, sew vertical seam 3 using 1/4″ seam allowance, from end with hem 2a to opposite end and stop the stitching approximately 1″ from end with hem 2b. Next the tube is turned so right side of fabric is facing out leaving opening at either end. Create a loop with cord 5 and place inside the cover at end near hem 2b. The cord 5 is typically 1/16″ thick and 1 ½″ in length and is made of satin or any other such material. Finish with top stitching 4 to close the length. Add hook 6 to cord loop 5. Hook 6 is typically ¾″ in length and is made of plastic, metal or some other material.

FIG. 2 shows a threading device 7 that is roughly 3″ in length and is made of plastic or other such material. It has a vertical slit 8 that extends its full length. The threading device 7 is placed inside the end of the cover in FIG. 1 where hem 2a resides to complete the production of this embodiment. The finished cover forms a tube that is approximately 31 ½″ long and ½″ wide on either side if pressed flat (or 1″ around). The cover surrounds the majority of the length of most earbud and earphone cords.

The threading device 7 is used to place the cover in FIG. 1 on a set of earbud or earphone cords. In FIG. 3, the vertical slit 8 on threading device 7 is opened and placed around earbud cord 9 at end of the cord near the earbud connector. Once the threading device 7 is in place surrounding the cord 9, the earbud connector 10 (FIG. 4) is placed into the opening at the top of cover 11 (FIG. 4). The threading device 7 is then pushed through the length of cover until the connector exits through the other end. The threading device 7 can be stored inside the cover or removed for future use.

FIG. 5 illustrates another embodiment of the cover. The cover is made of a fabric 1 or any other soft material. The fabric 1 is made of nylon, spandex, polyester, rayon, cotton or any combination of various fabrics. The fabric 1 contains solid colors, printed patterns and other selected printed motifs.

To make the cover in FIG. 5, begin with a piece of fabric 1 with overall dimensions of roughly 32″ by 1 ½″. First hem each of the ends 2a and 2b by turning each end by ¼″ with wrong sides of the fabric facing and sew to create finished edge. Next with wrong sides of fabric facing, sew vertical seam 14 with approximate length of stitching to be 1″ beginning at end of cover near hem 2a using roughly ¼″ seam allowance. Next, zipper slider 12 is removed from zipper tape 13. Zipper slider 12 is made of metal, plastic or any other material. Zipper tape 13 is approximately 30″ long. Zipper teeth on zipper tape 13 are made of metal, plastic or any other material. With the wrong side of fabric facing up, place zipper tape 13 right side down on fabric approximately ¼″ below seam 14. Tack down zipper at top with ¼″ horizontal stitch. Next sew 2 lines of vertical stitching to secure the zipper tape 13. Vertical stitching will stop roughly 1″ from end with hem 2b. FIG. 6 shows an exploded view of placement of horizontal stitch 15 and vertical stitching 16a and 16b on zipper tape 13. The tube is then turned so right side of fabric is facing out. The zipper slider 12 is placed on zipper tape 13. Create a loop with cord 5 and place inside the cover at end near hem 2b. The cord 5 is typically 1/16″ thick and 1 ½″ in length and is made of satin or any other such material. Finish with top stitching 4 to close the length. Add hook 6 to cord loop 5. Hook 6 is typically ¾″ in length and is made of plastic, metal or some other material. The finished cover forms a tube that is approximately 31 ½″ long and ½″ wide on either side if pressed flat (or 1″ around). The cover surrounds the majority of the length of most earbud and earphone cords.

To use the zipper cover, pull zipper down to unzipped position (near end with hem 2b). The threading device 7 is not used in this embodiment. Insert the earbud or earphone connector through opening at end of cover near hem 2a and feed connector through cover for approximately 1″ under seam 14. When connector appears through opening, pull on the connector so the length of the cord follows behind Take the connector and feed it through the opening at the bottom near stitching 4 until connector exits opening at bottom near hem 2b. Zip up the zipper to complete placing the cover on the cords.

The decorative cover is easy to use and keeps earbud and earphone cords protected and untangled. The hook on the end of the cover may be used to hold a key (to home, locker, desk, car, etc.) or to hold a student/employee badge or to secure cord to a jogging shirt or for any other use determined by the owner. When not in use, the cover remains on the earphone cord and is easily rolled up and placed in a pocket or bag for tangle-free storage. The cover is visually appealing and is made in variety of colors, patterns and motifs. The lightweight, sleek cover is easily removed and interchanged for a new fashion statement or personal preference.

1. A cover for a pair of earbuds of the type having a cord which has at one end an audio connector or jack and proximate the other end a split in said cord to yield two cord extensions that each have at its end a small, in-ear loudspeaker, said cover comprising:
a tubular sleeve having an outer and inner surface that each extend between a proximal and a distal end of said sleeve, and an opening from said outer to inner surface at each of said ends with a hook attached to distal end,
wherein said sleeve having configuration adapted to allow said audio connector using a threading device to enter said sleeve proximate end opening and pass along said inner surface to exit through said opening at said sleeve distal end,
a slit in said sleeve that extends from said sleeve proximate end and towards said distal end until said slit terminates in a terminal end and has a specified slit length with a free edge on each side of said slit, and
a two-part means for opening and closing a desired length or said slit length, said means having a configuration adapted to allow one part of said means to be affixed to each of said two free edges of said slit at said sleeve proximate end and to extend to said slit terminal end and be detachably joined together over a desired length of said slit length so as to open and close said sleeve along said slit to expose a greater or lesser length of said cord that adjoins each of said small, in-ear loudspeakers.
